(19) United States
(12) Patent Application Publication
(10) Pub. No.: US 2005/0201099 A1
(43) Pub. Date: Sep. 15, 2005

(54) Demountable lampshade

(76) Inventor: Teng Li Chen, Hui-Yang City (CN)

Correspondence Address: Yi-Wen Tseng, 4331 Stevens Battle Lane, Fairfax, VA, 22033, US

(21) Appl. No.: 10/798,417

(22) Filed: Mar. 12, 2004

(51) Int. Cl. F21V 1/00

(52) U.S. Cl. 362/317

(57) ABSTRACT

A demountable lampshade includes a plurality of shade piece and a connecting base. Each including a frame with a upper frame section, a lower frame section and two side frame sections, and at least one side frame having a buckle member formed thereon to clamp two corresponding side frame sections when the shade pieces are mounted to each other. The connecting base located to the upper frame sections of the mounted shade pieces, including an outer ring, an inner ring and a plurality of connecting rods connected between the outer and inner rings. Accordingly, the lampshade structure can be rapidly and easily disassembled for conveniently storing or transporting.

### BACKGROUND OF THE INVENTION

The present invention relates generally to a lampshade structure and, more particularly, to a demountable lampshade for various lamps, such as the desk lamps, table lamps and floor lamps etc, which has a delicate structure for assembly and can be easily disassembled for storage.

The conventional lampshade structure includes a frame body and a shade body embracing the frame body. In order to have sufficient structural strength and ensure safety, the conventional frame body is generally made of an upper collar, a lower collar much larger than the upper collar, and a plurality of ribs welded to the upper and the lower collars to form the frame body. Such frame body has rigid structure. However, after welded, the frame body cannot be disassembled and will occupy much room. Therefore, when storing or transporting a large amount of products, very much room will be occupied to lead to great inconvenience in storage and transportation. This results in increased cost and is not economic.

Accordingly, the applicant has invented “Rotabaly collapsible lampshade” applied for China patent application No. ZL02248113.3, which includes three shade bodies, a retractable base and three clamping fixtures. The lampshade can be folded by rotating the retractable base. However, because this structure is more complicated, the manufacturing expense can not be reduced to meet the requirement of regular-priced lamp equipments.

Therefore, there exist inconvenience and drawbacks for practically application of the above-mentioned conventional lampshade structure. There is thus a substantial need to provide an improved lampshade that resolves the above drawbacks and can be used more conveniently and practically.

### BRIEF SUMMARY OF THE INVENTION

The present invention provides a demountable lampshade which can be rapidly and easily disassembled.

Further, the present invention provides a demountable lampshade which can be disassembled into multiple shade pieces to be stacked together for convenient storage and transportation.

Accordingly, a demountable lampshade of the present invention includes a plurality of shade piece and a connecting base. Each including a frame with a upper frame section, a lower frame section and two side frame sections, and at least one side frame having a buckle member formed thereon to clamp two corresponding side frame sections when the shade pieces are mounted to each other. The connecting base located to the upper frame sections of the mounted shade pieces, including an outer ring, an inner ring and a plurality of connecting rods connected between the outer and inner rings.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These, as well as other features of the present invention, will become more apparent upon reference to the drawings wherein:

FIG. 1 shows an exploded view of a demountable lampshade according the present invention;

FIG. 2 shows a partially assembly view of the connecting base being mounted to the shade pieces of the lampshade;

FIG. 3 shows a perspective view of the assembly of the present invention;

FIG. 4 shows an enlarged view of part A of the FIG. 3;

FIG. 5 shows another perspective view of the assembly of the present invention; and

FIG. 6 shows the lampshade disassembled into multiple shade pieces in stacking.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

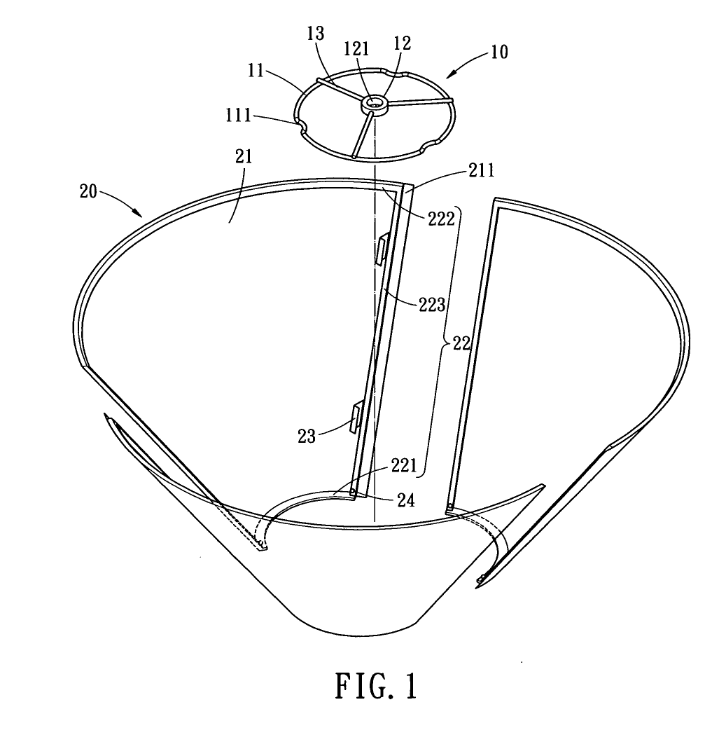

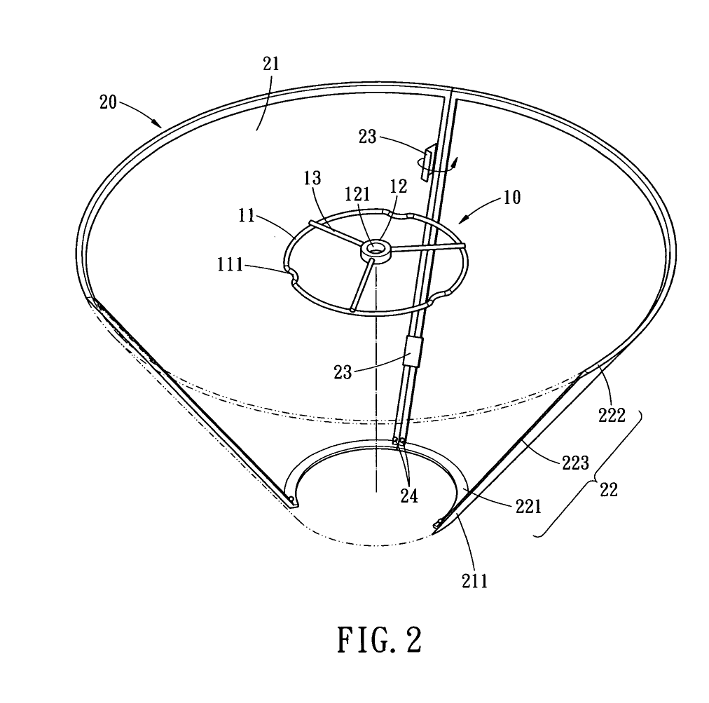

FIGS. 1 to 3 show the exploded view, partially assembling view and perspective view of a demountable lampshade structure of the present invention, respectively. The lampshade includes a connecting base 10 and a plurality of shade pieces 20.

The connecting base 10 includes an outer ring 11, an inner ring 12 and three connecting rods 13. The diameter of the inner ring 12 is much smaller than the outer ring 11, and the connecting rods 13 are connected between the outer ring 11 and the inner ring 12. The outer ring 11 further includes a plurality of indentations 111 symmetrically formed on the circumference thereof. A round hole 121 of the inner ring 12 is to mount on a lamp stand (not shown).

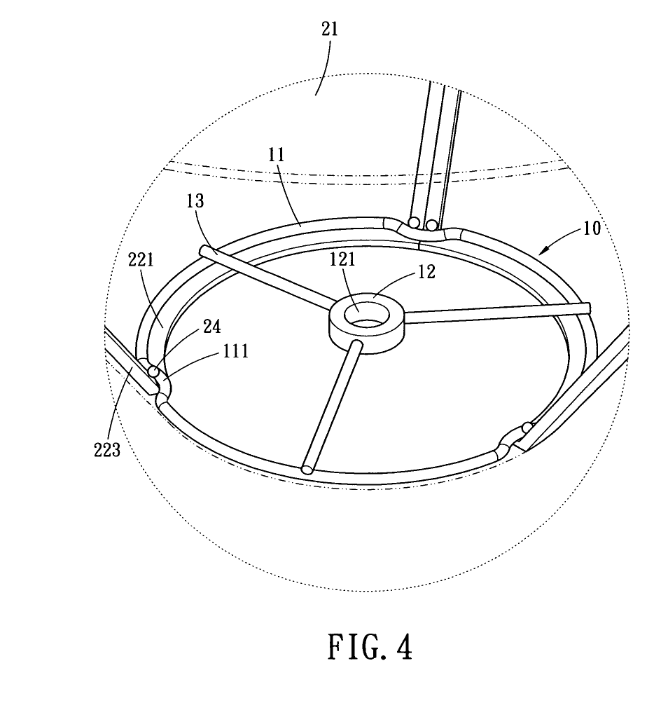

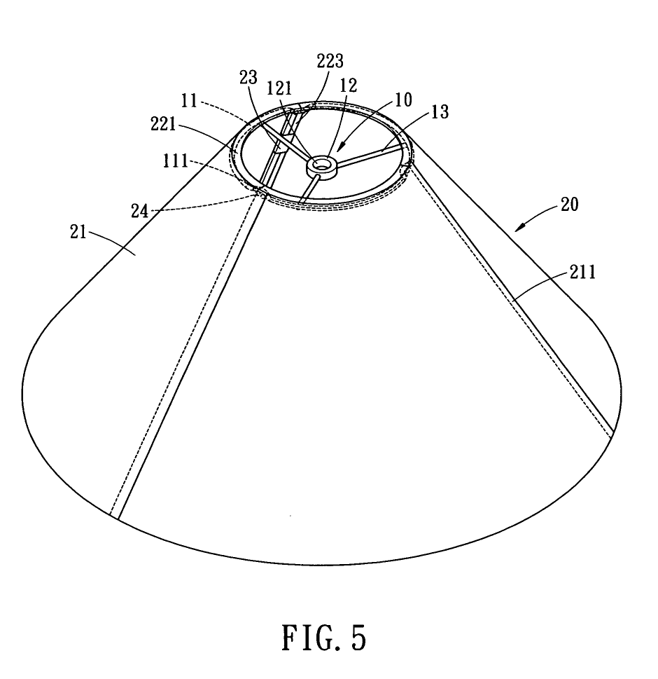

The number of the fanlike shade pieces 20 can be two, three or four etc to be put together to form a conical lampshade as in the preferred embodiment of the present invention. However, the shade piece 20 can be in other shape such as the rectangle to form a pyramidical lampshade. Nevertheless, the number the shade pieces must be equal to the number of the indentations 111. In this preferred embodiment, there are three identical fanlike shade pieces 20 to be mounted with each other to form the lampshade structure. The shade piece 20 includes a shade body 21 and a frame 22 surrounding the shade body 21. The frame 22 is constructed by an upper frame section 221, a lower frame section 222 and two side frame sections 223. The shade body 21 can be made of plastic material such as PS (PolyStyrene) or PVC (PolyVinyl Chloride) plastic. The shade body 21 is outstretched at one side of the side frame sections to form an overlapping cover 211 rested on the other shade piece 20 while two shade pieces are mounted together. Moreover, each shade piece 20 has at least one buckle member 23 formed on the side frame section 223. In this preferred embodiment, there are two buckle members 23 formed on only one side frame section 223 for each shade piece 20. The buckle member 23 is pivotally connected to the side frame section 223; therefore, after two shade pieces 20 are mounted together, the buckle member 23 can clamp on the adjacent side frame sections 223 22 to fasten the connection of two shade pieces 20. Furthermore, a protrusion 24 is formed near each end of the side frame section 223 connected with the upper frame section 221. As such, when outer ring 11 of the connecting base 10 is located on the upper frame sections 221 with the indentations 111 respected to two corresponding side frame sections 223 to assemble the shade pieces 20, via the support of the protrusions 24, the connecting base 10 is mounted between the upper frame sections 21 and the protrusions 24, as shown in FIGS. 4 and 5.

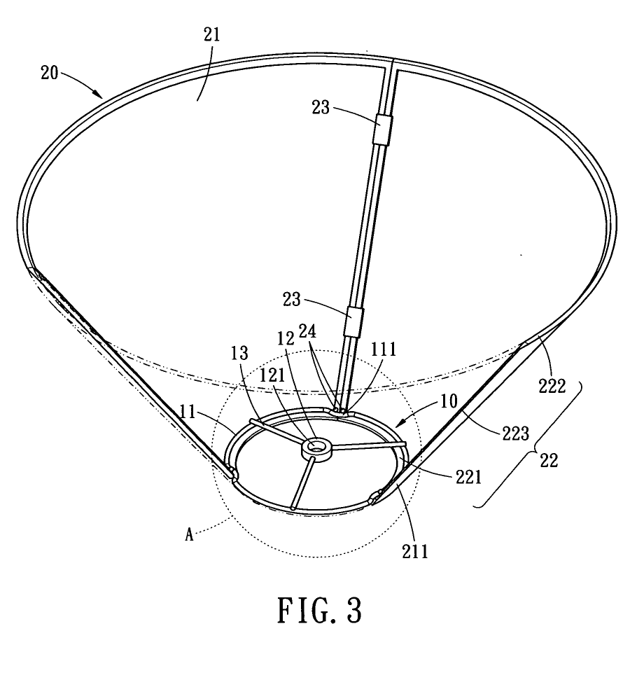

In assembly, each two shade pieces 20 are put together with the corresponding side frame section 223 of each shade piece 20 clamped by the buckle members 23. After all shade pieces 20 are firmly mounted to each other, the outer ring 11 of the connecting base 10 is pressed against the protrusion 24 to located the connecting base 10 between the protrusion 24 and the upper frame sections 221 of the shade pieces 20, as shown in FIG. 3. As shown in FIG. 5, the assembled lampshade of the present invention can then be mounted to the lamp stand through the round hole 121.

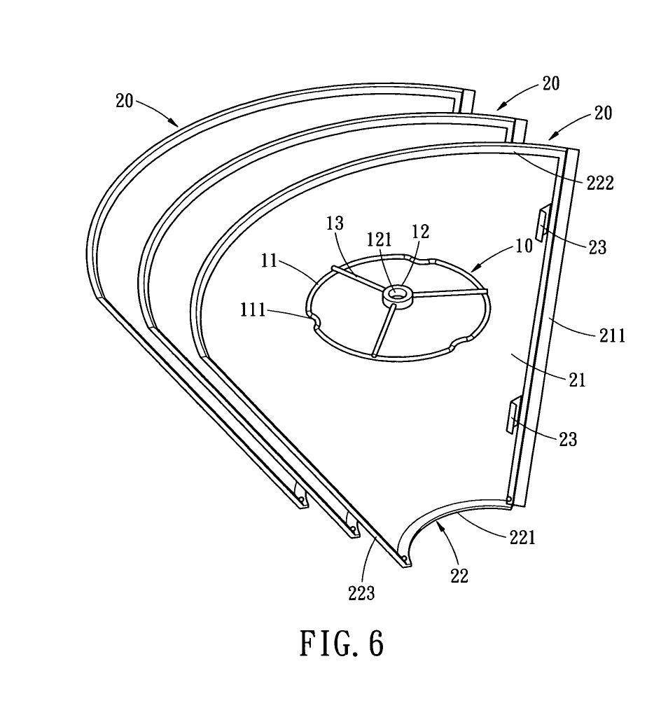

Finally, please refer to FIG. 6. The lampshade of the present invention can be dismounted into identical shade pieces 20 for storage. Therefore, it is convenient in transportation of a lamp including the demountable lampshade of the present invention.

According to the lampshade structure of the present invention, it provides at least the advantages as follows.

1. The demountable connection of the connecting base and the shade pieces can provide a rapid and easy assembly and disassembly.

2. The disassembled multiple shade pieces can be stacked together to reduce the occupying room for convenient storage and transportation.

3. The overlapping cover in the connection of two shade pieces provides a neat and smooth appearance of the lampshade, and further improves connecting strength of the whole structure.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A demountable lampshade, comprising:
a plurality of shade piece, each including a frame with a upper frame section, a lower frame section and two side frame sections, and at least one side frame having a buckle member formed thereon to clamp two corresponding side frame sections when the shade pieces are mounted to each other; and
a connecting base located to the upper frame sections of the mounted shade pieces, including an outer ring, an inner ring and a plurality of connecting rods connected between the outer and inner rings.

2. The demountable lampshade of claim 1, wherein a protrusion is formed near an end of the side frame section connected with the corresponding upper frame section of each shade piece so that the outer ring is located between the protrusions and the upper frame sections of the mounted shade pieces.

3. The demountable lampshade of claim 2, wherein the outer ring includes a plurality of indentations with respected to the protrusions.

4. The demountable lampshade of claim 3, wherein a diameter of the inner ring is much smaller than a diameter of the outer ring.

5. The demountable lampshade of claim 3, wherein a number of the shade pieces is equal to a number of the indentations.

6. The demountable lampshade of claim 1, wherein two buckle member are formed on the side frame section.

7. The demountable lampshade of claim 1, wherein the buckle member is pivotally formed on the side frame section for clamping.

8. The demountable lampshade of claim 1, wherein the shade piece has a fanlike shape.

9. The demountable lampshade of claim 1, wherein a number of the shade pieces is two.

10. The demountable lampshade of claim 1, wherein each shade piece includes a shade body is outstretched at one side frame section to form an overlapping cover on the other shade piece while two shade pieces are mounted together.

11. The demountable lampshade of claim 10, wherein the shade body is made of a plastic material of PS (PolyStyrene).

12. The demountable lampshade of claim 10, wherein the shade body is made of a plastic material of PVC (PolyVinyl Chloride)
